(19) United States
(12) Patent Application Publication
(10) Pub. No.: US 2018/0307225 A1
(43) Pub. Date: Oct. 25, 2018

(54) METHOD FOR PILOTING A ROTARY WING DRONE, RELATED COMPUTER PROGRAM, ELECTRONIC APPARATUS AND DRONE

(71) Applicant: PARROT DRONES, Paris (FR)

(72) Inventors: Martin Line, Paris (FR); Edouard Leurent, Paris (FR)

(21) Appl. No.: 15/956,161

(22) Filed: Apr. 18, 2018

(30) Foreign Application Priority Data
Apr. 19, 2017 (FR) 17 53380

(51) Int. Cl. G05D 1/00; G05D 1/08; G01C 23/00; B64C 39/02

(52) U.S. Cl. CPC G05D 1/0016; G05D 1/0094; G05D 1/0808; B64C 2201/127; B64C 39/024; B64C 2201/108; G01C 23/005

(57) ABSTRACT

The invention relates to a method for piloting a rotary wing drone, the method being implemented by an electronic apparatus for piloting the drone, the drone being configured to have an on board camera. The method comprises calculating different types of navigation setpoint(s) of the drone, based on different types of piloting instructions for the movement of the drone, a type of piloting instruction being capable of modifying at least an attitude angle of the drone and/or the movement speed of the drone, each type of piloting instruction respectively being associated with a type of navigation setpoints, the calculation comprising, for at least one type of piloting instructions: determining the sighting axis of the camera; obtaining at least one navigation setpoint associated with at least one type of piloting instructions based on the sighting axis of the camera.

### CROSS-REFERENCE TO RELATED APPLICATIONS

This application is a U.S. non-provisional application claiming the benefit of French Application No. 17 53380, filed on Apr. 19, 2017, which is incorporated herein by reference in its entirety.

### FIELD

The present invention relates to a method for piloting a rotary wing drone, the method being implemented by an electronic apparatus for piloting the drone, the drone being configured to have an onboard camera.

The invention also relates to a non-transitory computer-readable medium including a computer program including software instructions which, when executed by a computer, implement such a method for piloting a rotary wing drone.

The invention also relates to an electronic apparatus for piloting a rotary wing drone.

The invention also relates to a rotary wing drone configured to have an onboard camera, comprising at least one electronic piloting apparatus of the aforementioned type.

### BACKGROUND

The invention relates to the field of drones, i.e., remotely-piloted flying motorized apparatuses. The invention in particular applies to rotary wing drones capable of moving in the air using at least one rotor actuated by at least one motor. There are single rotary wing drones (i.e., single-rotor), such as helicopters, or multiple rotary wing drones (i.e., multi-rotor) such as quadcopters (also called quadripodes) or other over-actuated drones such as hexacopters or octocopters, etc.

The rotary wing drones, for example, of the quadcopter kind are capable of holding a fixed point and moving as slowly as desired, which makes them much easier to pilot, even for inexperienced users.

Traditionally, for a rotary wing drone provided with a camera, the camera comprising an image sensor, the piloting of the drone (i.e., the control of all of the movements of the drone during flight) is simply independent of the image acquisition done by the camera on the drone.

Because the image acquisition currently has no impact on the control of the movements of the drone, it is not always easy for a user to implement appropriate piloting to optimize the desired image acquisition.

### SUMMARY OF THE INVENTION

One of the aims of the invention is then to propose a method for piloting a rotary wing drone configured to have an onboard camera, making it possible to facilitate the piloting by the user to obtain an optimal image acquisition.

To that end, the invention relates to a method for piloting a rotary wing drone, the method being implemented by an electronic apparatus for piloting the drone, the drone being configured to have an onboard camera,

the method comprising calculating different types of navigation setpoint(s) of the drone, based on different types of piloting instructions for the movement of the drone, a type of piloting instruction being capable of modifying at least an attitude angle of the drone and/or the movement speed of the drone, each type of piloting instruction respectively being associated with a type of navigation setpoints,
the calculation comprising, for at least one type of piloting instructions:
determining the sighting axis of the camera,
obtaining at least one navigation setpoint associated with said at least one type of piloting instructions based on the sighting axis of the camera.

The method for piloting a rotary wing drone according to the invention automatically taking account of the sighting axis of the camera to calculate the navigation setpoint(s) transmitted to the motor(s) of the rotary wing drone then makes it possible to optimize the piloting in real time in order to avoid losing sight of the target for which the user wishes to acquire one or several images.

In other words, relative to the state of the art, a modification of the setpoint calculation is carried out to allow, simultaneously with the movement of the drone, an optimal image acquisition of a target selected by the user using orientation instructions of the camera.

Thus, the method according to the invention corresponds to a slaving of the movement of the drone based on the sighting axis of the camera on which the image acquisition zone is centered.

Hereinafter, “piloting method” refers to the automatic method according to the invention making it possible to convert the piloting instructions (i.e., comprised in the user commands) entered by the user into motor commands. In other words, the piloting method implemented automatically according to the invention allows real-time assistance for the manual piloting by the user.

According to other advantageous aspects of the invention, the method for optimizing the flying tilt of a drone includes one or more of the following features, considered alone or according to all technically possible combinations:
the determination of the sighting axis of the camera comprises processing an orientation instruction of the camera, received by the electronic piloting apparatus of the drone, and/or previously stored in the memory of the electronic piloting apparatus of the drone;
the obtainment of said at least one navigation setpoint based on the sighting axis automatically implements, using the electronic piloting apparatus of the drone, a change of coordinate system,
the change of coordinate system being based on the obtainment of a current triaxial coordinate system for calculating navigation setpoint(s) by rotating a previous triaxial coordinate system for calculating a navigation setpoint around an invariant axis of said previous coordinate system, converting one of the other two axes of the previous coordinate system into the sighting axis of the camera;
the method comprises detecting a change of sighting axis of the camera and reiterating the calculation of at least one navigation setpoint of the drone upon each detected change of sighting axis;
the method can be activated by entering a first predetermined user command;
the method comprises controlling the speed of the drone modified by the application of a predetermined minimum movement speed associated with each type of piloting instruction, said application being able to be activated by entering a second predetermined user command;
when said second predetermined user command is present and when the type of piloting instruction is capable of modifying the roll angle of the drone according to a desired roll angle, the type of associated navigation setpoint(s) remains independent of the sighting axis of the camera,
the method then comprises determining a yaw angle associated with the desired roll angle and a horizontal rotation speed setpoint of the camera.

The invention also relates to a non-transitory computer-readable medium including a computer program including software instructions which, when executed by a computer, implement a method as defined above.

The invention also relates to an electronic apparatus for piloting a rotary wing drone, configured to have an onboard camera, the electronic apparatus comprising a unit for calculating different types of navigation setpoint(s) of the drone, based on different types of piloting instructions for the movement of the drone, a type of piloting instruction being capable of modifying at least an attitude angle of the drone and/or the movement speed of the drone, each type of piloting instruction respectively being associated with a type of navigation setpoints,

the calculation unit comprising, for at least one type of piloting instructions:
a module for determining the sighting axis of the camera,
a module for obtaining at least one navigation setpoint associated with said at least one type of piloting instructions based on the sighting axis of the camera.

The invention also relates to a rotary wing drone, configured to have an onboard camera, the drone comprising at least one electronic piloting apparatus.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a perspective view of an electronic system for guiding a drone according to the invention, comprising a rotary wing drone, capable of moving through the air under the control of remote control equipment;

FIG. 2 is a block diagram of different members for controlling slaving and piloting aid for an electronic apparatus of the drone according to the invention;

FIG. 3 is a flowchart of a piloting method of the drone according to the invention;

FIG. 4 is a schematic illustration of the change of coordinate system, implemented according to the invention, based on the sighting axis of the camera;

FIGS. 5 and 6 illustrate an example of ergonomic distribution of commands made available to the user on his remote control according to two different alternative embodiments.

### DETAILED DESCRIPTION

In the rest of the description, the expression “substantially equal to” refers to an equality relationship to within plus or minus 10%, i.e., with a variation of no more than 10%, also preferably to an equality relationship to within plus or minus 5%, i.e., with a variation of no more than 5%.

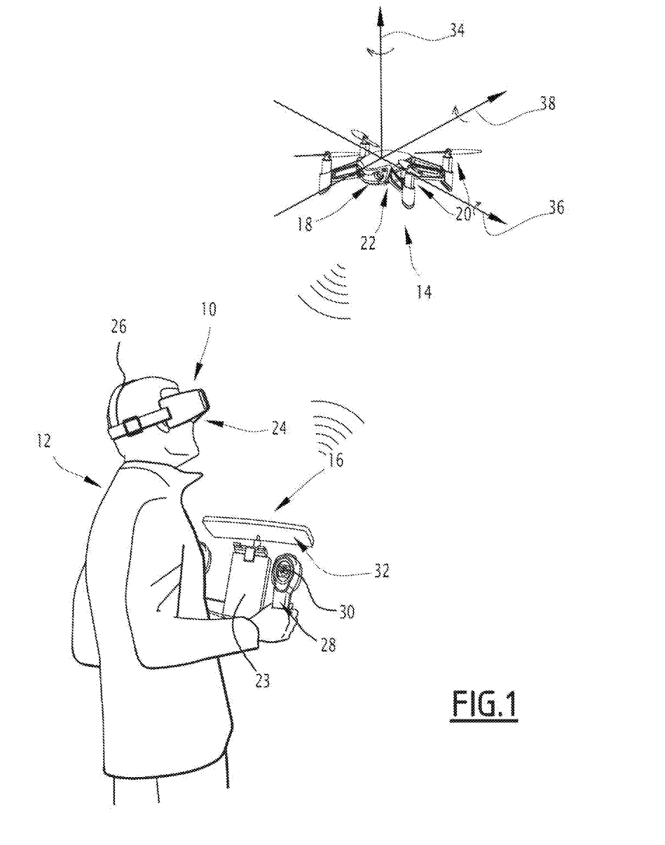

In FIG. 1, an electronic system for guiding a drone makes it possible, using an electronic viewing system 10, for a user 12 to optimize the guiding of a drone 14.

The drone 14 is a motorized flying vehicle able to be piloted remotely, in particular via a control stick 16 allowing the user 12 to enter his flight commands.

The drone 14, i.e., an aircraft with no pilot on board, comprises a camera 18 comprising a lens associated with an image sensor, not shown, configured to acquire an image of a scene including a plurality of objects.

The lens is for example a hemispherical lens of the fisheye type, i.e., covering a viewing field with a wide angle, of about 180° or more. The lens is positioned in front of the image sensor such that the image sensor detects the images through the lens.

When the image sensor is associated with a fisheye lens, it is possible for the user, by entering orientation instructions of the camera using the control stick 16, to orient the sighting axis (i.e., the viewing axis) of the camera virtually.

Indeed, a method for capturing image(s) makes it possible to define a virtual image sensor by selecting a zone Zc with smaller dimensions relative to the actual dimensions of the image sensor, the zone Zc being centered on the sighting axis of the camera.

Obtaining an image from a zone Zc with smaller dimensions of the image sensor makes it possible to virtually orient the sighting axis of the camera in the direction of the window of the overall field of the camera corresponding to the zone Zc with smaller dimensions, without modifying the physical orientation of the camera, which remains immobile relative to the rotary wing drone 14.

According to another alternative, not shown, the camera is mounted rotating on a dedicated gimbal of the drone, such that its sighting axis can be modified mechanically and not virtually by digital processing as described above.

The drone 14 is for example a rotary-wing drone, including at least one rotor 20 (or propeller) actuated by at least one motor. In FIG. 1, the drone 14 includes a plurality of rotors 20, and is then called multi-rotor drone. The number of rotors 20 is in particular equal to four in this example, and the drone 14 is then a quadrirotor drone or quadcopter.

The drone 14 is also provided with a transmission module 22 to send, preferably wirelessly, to a piece of electronic equipment, such as the reception module, not shown, of the electronic viewing system 10, the reception module, not shown, of the control stick 16 or the reception module of the multimedia touchscreen digital tablet 23 mounted on the control stick 16, not shown, the image(s) acquired by the image sensor.

According to the example shown in FIG. 1, an electronic viewing system 10 allows the user 12 to view images, in particular images of the video received from the rotary wing drone 14.

The electronic viewing system 10 comprises an electronic apparatus, for example a smartphone, provided with a display screen, and a headset 24 including a reception support of the electronic apparatus, a bearing surface against the face of the user 12, across from the user's eyes, and two optical devices positioned between the reception support and the bearing surface.

The headset 24 further includes a maintaining strap 26 making it possible to maintain the headset 24 on the head of the user 12.

The electronic apparatus is removable with respect to the headset 24 or integrated into the headset 24.

The electronic viewing system 10 is for example connected to the control stick 16 via a data link, not shown, the data link being a wireless link or a wired link.

In the example of FIG. 1, the electronic viewing system 10 further comprises a reception module, not shown, configured to receive at least one image from the rotary wing drone 14, the transmission of the image preferably being done wirelessly.

The viewing system 10 is for example a virtual-reality viewing system, i.e., a system allowing the user 12 to view an image in his field of view, with a field of view (or field of vision, FOV) angle with a large value, typically greater than 90°, preferably greater than or equal to 100°, in order to procure an immersive view (also called “FPV”, First Person View) for the user 12.

Such a viewing system 10 is optional and in particular makes it possible to enhance the “user experience” in the immersive piloting configuration, piloting without using this viewing system also being possible.

The control stick 16 is known in itself, and for example makes it possible to pilot the rotary wing drone 14. The control stick 16 comprises two gripping handles 28, each being intended to be grasped by a respective hand of the user 12, a plurality of control members, here including two joysticks 30, each being positioned near a respective gripping handle 28 and being intended to be actuated by the user 12, preferably by a respective thumb.

The control stick 16 also comprises a radio antenna 32 and a radio transceiver, not shown, for exchanging data by radio waves with the rotary wing drone 14, both uplink and downlink.

Additionally, or alternatively in light of the viewing system 10, the digital multimedia touchscreen tablet 23 is mounted on the control stick 16 to assist the user 12 during piloting of the rotary wing drone 14.

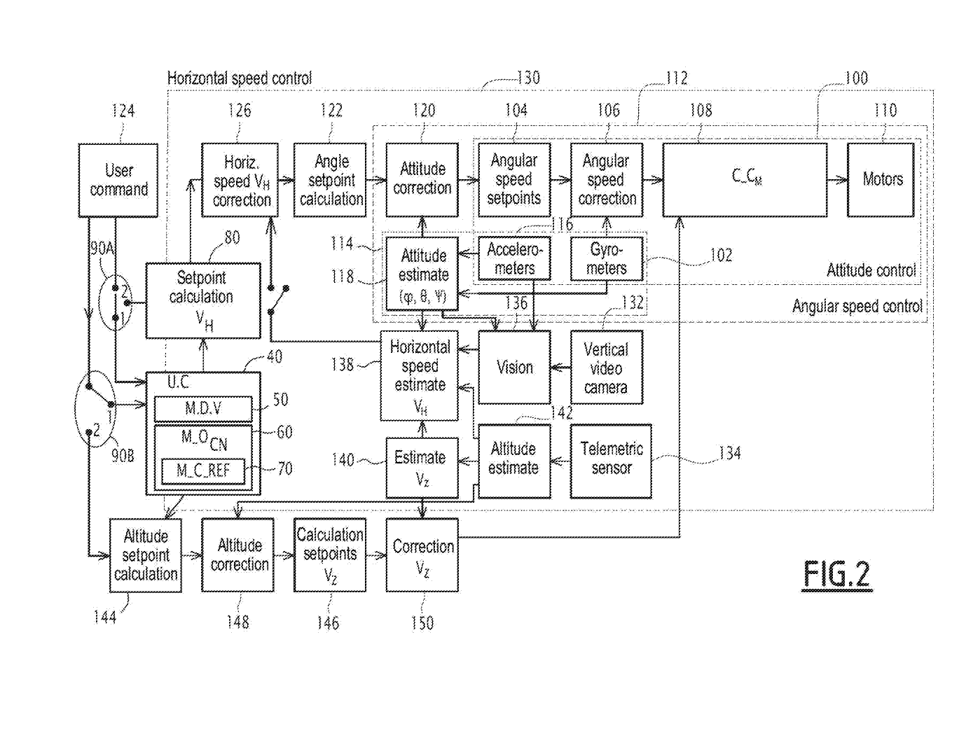

The control stick 16 is configured to send the commands 124 from the user to an automatic pilot electronic apparatus (i.e., automatic aid for manual piloting by the user) integrated into the rotary wing drone, a schematic example of which is shown in the form of a block diagram in FIG. 2.

The electronic guiding system of the drone described above, and optionally comprising a virtual-reality viewing system 10, is given as an example, the invention being able to be implemented with other types of drone guiding systems, and if applicable with no viewing system 10.

The piloting of the drone 14 consists of moving the latter by:
rotation around a yaw axis 34, to cause the main axis of the drone to pivot to the right or the left
rotation around a pitch axis 36, to cause it to move forward or backward
rotation around a roll axis 38, to offset it to the right or left; and
translation downward or upward by changing the throttle regime, so as to respectively decrease or increase the altitude of the drone

FIG. 2 is a block diagram of different control members for slaving and piloting of the drone 14, as well as correcting movements of the image according to the technique of the invention.

It will be noted that, although these diagrams are shown in the form of interconnected circuits, the implementation of the various functions is, according to one embodiment, essentially software-based, this depiction being provided purely as an illustration.

According to another embodiment, the invention is capable of being implemented using one or several programmable logic circuit(s), such as an FPGA (Field Programmable Gate Array), or in the form of a dedicated integrated circuit, such as an ASIC (Application Specific Integrated Circuit) mounted on an electronic board onboard the rotary wing drone 14.

Generally, as illustrated in FIG. 2, the piloting system involves several interleaving loops for controlling the horizontal speed, the angular speed of the attitude of the drone 14 as well as altitude variations, automatically or upon command from the user.

According to the present invention, the automatic piloting electronic apparatus (i.e., automatic aid for manual piloting by the user) for example allows the user to benefit from at least two piloting modes.

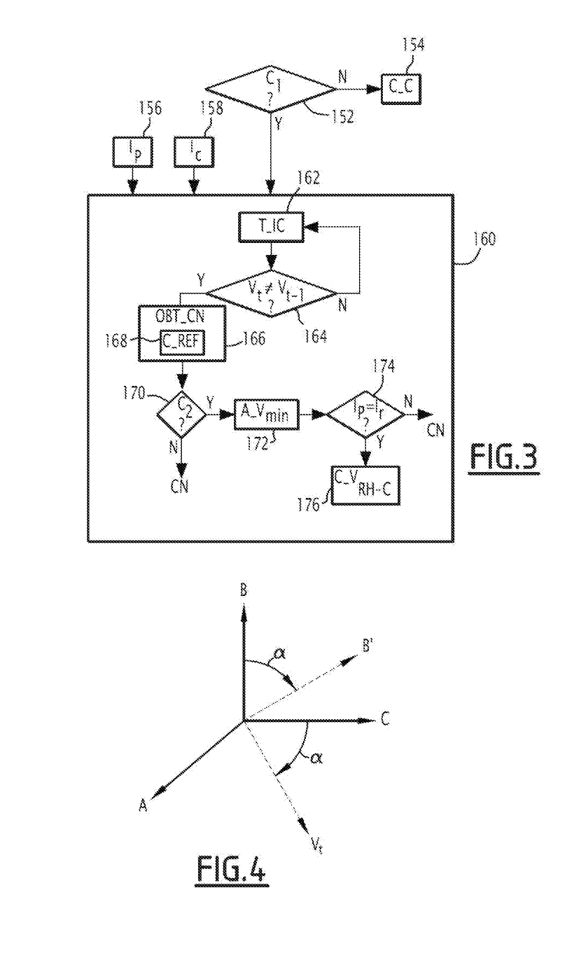

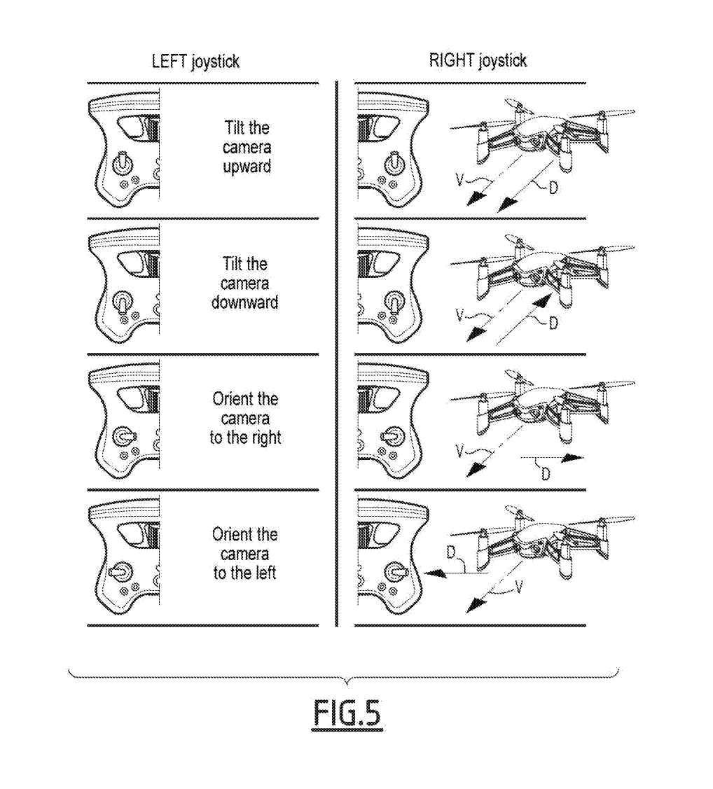

Such an electronic apparatus comprises or is capable of being connected to an information processing unit, not shown, for example made up of a memory and a processor associated with the memory, the processor being able to execute a computer program including software instructions which, when executed, implement a piloting method according to the invention as described below in connection with FIGS. 3 and 4.

The first mode 1, or “camera mode” for automatic assistance in the movement of the drone 14, proposed according to the invention, proposes to the user to establish a correlation (i.e., a dependency or slaving) between the movement of the drone and the image acquisition by the camera. Such a first mode aims to improve the image acquisition quality by automatically assisting the user to pilot the drone such that the sighting axis of the camera is taken into account in real-time.

To that end, the automatic piloting electronic apparatus according to the invention comprises a unit U_C for calculating 40 different types of navigation setpoint(s) CN of the drone, based on different types of piloting instructions I_{P} for the movement of the drone indicated within the user commands 124.

One type of piloting instruction I_{P} is capable of modifying at least an attitude angle (i.e., the pitch angle θ, and/or the roll angle φ, and/or the yaw angle ψ) of the drone 14 and/or the movement speed of the drone 14 (i.e., acceleration or deceleration), and is respectively associated with a type of navigation setpoints CN.

For example, a first type of piloting instruction I_{P1} aims only to modify the pitch angle θ of the drone, a second type of piloting instruction I_{P2} aims only to modify the roll angle φ of the drone, a third type of piloting instruction I_{P3} aims only to modify the yaw angle ψ of the drone, a fourth type of piloting instruction I_{P4} aims to modify both the roll angle φ and the pitch angle θ of the drone, a fifth type of piloting instruction I_{P5} aims to modify the yaw ψ angle of the drone and its movement speed, etc.

The calculation unit 40 comprises, for at least one type of piloting instructions I_{P}:
a module M.D.V. for determining 50 the sighting axis V of the camera 18,
a module M_O_{CN} for obtaining 60 at least one navigation setpoint CN associated with said at least one type of piloting instructions I_{P} based on the sighting axis of the camera 18.

In particular, the module M_O_{CN} for obtaining 60 at least one navigation setpoint CN comprises a module 70 for changing coordinate system M_C_REF, the change of coordinate system (i.e., frame of reference) being based on the obtainment of a current triaxial coordinate system for calculating navigation setpoint(s) by rotating a previous triaxial coordinate system for calculating a navigation setpoint around an invariant axis of said previous coordinate system, converting one of the other two axes of the previous coordinate system into the sighting axis of the camera as subsequently illustrated in FIG. 4.

Thus, the calculation unit 40 is, according to the “camera mode” proposed according to the present invention, capable of delivering, as output, navigation setpoints CN expressed in a triaxial coordinate system, one of the axes of which corresponds to the sighting axis V of the camera, and sending them both as input for an altitude setpoint calculation circuit 144 and as input for a horizontal speed setpoint calculation circuit V_{H} 80.

In other words, navigation setpoint CN refers to data making it possible to calculate an altitude setpoint and/or a horizontal speed setpoint.

During the activation of this piloting mode 1 in “camera mode”, any change of sighting axis associated with a change of incline or orientation instruction of the camera I_{C} received within user commands 124 is capable of modifying, in real time, the coordinate system in which the navigation setpoints are expressed.

Such a mode 1, called “camera mode”, is able to be activated, using two switches 90A and 90B triggered, synchronously, on this mode 1, by entering a first predetermined command C₁ entered by the user using one of the joysticks 30, a dedicated button, for example a pushbutton or touch-sensitive button, or any other technically possible means allowing the user to activate the mode 1, such as a voice command.

According to another alternative, this “camera mode” is automatically activated when the user triggers the capture period by the camera 18. In other words, according to this alternative, the triggering of the image acquisition (photo or video) by the camera 18 is equivalent to an activation command C1 of the piloting “camera mode” proposed according to the invention.

The second mode 2, or “traditional piloting mode”, retains total independence of the movements of the drone relative to the sighting axis of the camera.

This traditional piloting mode 2 is for example activated by default, the two switches 90A and 90B then being triggered, synchronously, on this mode 2 either by applying another predetermined command, not shown, entered by the user, or an “inverse” command with respect to the first command C₁ (e.g., new pressure on a pushbutton causing it to rise).

According to this traditional piloting mode 2, the frame of reference to be used to determine the altitude or horizontal speed setpoints remains constant throughout the entire activation duration of this second mode 2 and for example corresponds to a reference frame of reference, such as a horizontal triaxial coordinate system (i.e., one plane of which defined by two axes, for example an axis y and an axis x, corresponds to the plane of the flight horizon of the drone 14, such a horizontal triaxial coordinate system being capable of rotating with the drone).

According to one particular aspect of the invention, not shown, even in the presence of the first command C₁, the piloting mode 1 in camera mode is not necessarily activated for all types of piloting instructions I_{P}. As an example, such a piloting mode in camera mode is only activated for piloting instructions of type I_{P1} and I_{P3} previously outlined and the traditional piloting mode 2 (i.e., where the traditional calculation of navigation setpoints remains independent from the camera) is retained for piloting instructions of type I_{P2}, I_{P4} and I_{P5}.

More generally as described in connection with the activation of the traditional piloting mode 2, the electronic apparatus of FIG. 2 also comprises the control loop 100 for the angular speed, corresponding to the centermost loop, which on the one hand uses the signals provided by the gyrometers 102 and on the other hand uses a reference made up of angular speed setpoints 104. This information is applied as input of an angular speed correction stage 106, which in turn pilots a stage C_C_{M} (i.e., electronic apparatus) 108 for controlling motors 110 in order to command the rating of the different motors separately to correct the angular speed of the drone 14 by the combined action of the rotors driven by these motors.

The angular speed control loop 100 is interleaved in an attitude control loop 112, which operates from indications provided by an inertial unit 114 comprising the gyrometers 102, accelerometers 116 and a stage 118 that produces an estimate of the actual attitude of the drone 14. The data derived from these sensors are applied to the stage 118, which produces an estimate of the actual attitude of the drone 14, applied to an attitude correction stage 120. This stage 120 compares the actual attitude of the drone 14 to angle setpoints generated by a circuit 122 from commands directly applied by the user 124 and/or from data generated internally by the automatic pilot of the drone 14 via the horizontal speed V_{H} (or horizontal movement speed of the drone 14) correction circuit 126. The setpoints, potentially corrected, applied to the circuit 120 and compared to the actual attitude of the drone 14 are transmitted by the circuit 120 to the circuit 104 to command the motors appropriately.

Lastly, a horizontal speed control loop 130 includes a vertical video camera 132 and a telemetric sensor 134 serving as altimeter. A circuit 136 provides the processing of the images produced by the vertical camera 132, in combination with the signals from the accelerometer 114 and from the attitude estimating circuit 118, to produce data making it possible to obtain an estimate of the horizontal speeds along both pitch and roll axes of the drone 14, with or without using a circuit 138 (i.e., the circuit 138 enables, in a closed loop (i.e., closed switch), speed slaving that is optionally implemented).

According to one optional aspect that is not shown, such a circuit 138 for example uses data provided by a GPS or Galileo geolocation system to estimate the horizontal speed(s) V_{H}. The estimated horizontal speeds are corrected by the vertical speed estimate given by a circuit 140 and by an estimate of the value of the altitude, given by the circuit 142 from information from the telemetric sensor 134.

To control the vertical movements of the drone 14 in the traditional piloting mode, the user applies commands 124 to a circuit for calculating altitude setpoints 144, these setpoints being applied to a circuit for calculating ascent speed setpoints V_{Z} 146 via the altitude correction circuit 148 receiving the estimated altitude value given by the circuit 142. The calculated ascent speed V_{Z} is applied to a circuit 150 that compares this setpoint speed to the corresponding speed estimated by the circuit 140 and modifies the command data of the motors (electronic apparatus 108) accordingly by increasing or decreasing the rotation speed simultaneously on all of the motors so as to minimize the deviation between the setpoint ascent speed and the measured ascent speed.

The operation of the electronic piloting apparatus of FIG. 2 will now be explained using FIGS. 3 and 4.

In particular, FIG. 3 shows a flowchart of the method for piloting a rotary wing drone 14 implemented by the electronic apparatus of FIG. 2 according to the invention.

During a step 152, during the flight of the drone 14, at a moment t for receiving user commands 124, the electronic apparatus of FIG. 2 determines whether the user commands 124 comprise a first command C₁ for triggering the piloting mode 1 in “camera mode”.

If the user commands 124 lack N the first command C₁, the switches 90A and 90B switch, according to a step 154, to piloting mode 2, i.e., the traditional piloting mode (or if applicable, “remain” in piloting mode 2, if the previously activated piloting mode was already mode 2).

If, on the contrary Y, the user commands 124 comprise the first command C₁, the switches 90A and 90B switch, synchronously, to mode 1 for activating the calculation 40 unit U_C specific to the invention.

In other words, according to this step 152 for the piloting “camera mode”, the user commands 124 respectively corresponding to at least one piloting 156 instruction I_{P} and/or to at least one incline or orientation 158 instruction I_{C} of the camera 18 are transmitted as input to the calculation 40 unit U_C.

During step 160, the calculation of navigation setpoints according to the present invention is carried out each time user commands 124 are received comprising a piloting 156 instruction I_{P} and/or an incline or orientation 158 instruction I_{C} of the camera 18. Any change in piloting 156 instruction I_{P} and/or an incline or orientation 158 instruction I_{C} of the camera 18 will cause the calculation step 160 to be reiterated.

Such a calculation step 160 comprises, for a given piloting instruction I_{P}, first, a step 162 for determining the sighting axis V of the camera 18 by processing the incline or orientation 158 instruction I_{C} of the camera 18.

Such an incline or orientation instruction 158 of the camera 18 is received by the electronic piloting apparatus of the drone 14, and/or previously stored in the memory of the electronic piloting apparatus of the drone 14.

For example, such an incline or orientation 158 instruction I_{C} of the camera 18 is stored periodically during flight of the drone 14 within its memory, and for example corresponds to an incline or orientation 158 instruction I_{C} of the camera 18 received at a moment t−1 prior to switching to piloting mode 1 in “camera mode”.

Furthermore, according to one particular aspect, an incline or orientation 158 instruction I_{C} of the camera by default is for example stored at all times in the memory of the information processing unit on board the drone 14, so as to be able to carry out piloting mode 1 in “camera mode” as of the beginning of the flight of the drone 14 or with no incline or orientation 158 instruction from the camera 18 entered manually by the user using the control stick 16.

The incline or orientation 158 instruction I_{C} of the camera 18 corresponds to an incline α of the camera upward or downward (i.e., camera pitch) relative to the horizontal plane of the drone containing the pitch 36 and roll 38 axes as shown in FIG. 1, and/or to an orientation, not shown, of the camera, remaining in the horizontal plane of the drone 14, for example, on either side (i.e., on the left or right) of the longitudinal axis of the drone corresponding to the roll axis 38 (i.e., camera heading).

The sighting axis Vₜ at moment t is the optical axis of the camera 18 (or of the virtual image sensor as previously described) whose incline (and/or orientation, not shown) is represented by the incline angle α in a reference frame of reference, such as a horizontal triaxial coordinate system (i.e., a plane of which comprising two axes, for example an axis y and an axis x, corresponds to the plane of the flight horizon of the drone 14, such a horizontal triaxial coordinate system being capable of rotating with the drone), used according to traditional piloting mode 2.

Then, for each reception at a moment t of an incline or orientation instruction I_{C} of the camera 18, a step 164 for detecting a change of sighting axis Vₜ at moment t relative to the sighting axis Vₜ₋₁ at the previous moment t−1 is carried out.

If no N (i.e., no change of sighting axis), the navigation setpoint CN obtained at the preceding moment t−1 for the same piloting instruction I_{P} remains valid and is thus maintained.

If, on the contrary Y, a change of sighting axis V is detected, a step 166 for obtaining a navigation setpoint CNₜ associated with the piloting instruction I_{P} is carried out based on the sighting axis Vₜ of the camera.

In particular, the obtainment 166 of the navigation setpoint CNₜ based on the sighting axis automatically implements, using the electronic piloting apparatus of the drone 14, a step 168 for changing coordinate systems, as illustrated by FIG. 4.

Such a change of coordinate system (i.e., frame of reference used to express the navigation setpoints associated with the piloting instructions) is based on the obtainment of a current triaxial coordinate system for calculating navigation setpoint(s) comprising the axes (B′, Vₜ, A), by rotating a previous (A, B, C) triaxial coordinate system for calculating a navigation setpoint around an invariant axis of said previous coordinate system, for example the axis A as shown in FIG. 4, converting one of the other two axes of the previous coordinate system, for example the axis C, into the current sighting axis Vₜ of the camera.

In FIG. 4, the previous coordinate system (A, B, C) for example corresponds to the reference frame of reference associated with traditional piloting mode 2, such as a horizontal triaxial coordinate system (i.e., one plane of which comprising two axes, for example an axis y and an axis x, corresponds to the plane of the flight horizon of the drone 14). This previous coordinate system, after entering piloting mode 1 according to the “camera mode”, is then converted by rotation by an angle substantially equal to the angle α around the axis A, for example pitch 36, and a current coordinate system (A, B′, Vₜ).

Such a piloting mode 1 in “camera mode” in particular makes it possible to convert a piloting instruction I_{P}, which, according to traditional piloting mode 2, would allow the drone 14 to rise independently of the sighting axis Vₜ of the camera 14, into a navigation setpoint CN combining both an altitude setpoint and a horizontal speed setpoint that makes it possible for the camera to go in the sighting direction.

In other words, piloting mode 1 in “camera mode” makes it possible, from a photographic or cinematographic perspective, to zoom in and out, in other words to go toward or move away from the target of the camera, even if the camera 18 has no optical zoom and is immobile within the drone 14.

Furthermore, once the sighting axis Vₜ of the camera 18 is modified by the user, the method according to the invention is capable of detecting it and recalculating the navigation setpoint while expressing it in an appropriate frame of reference, one of the axes of which corresponds to the sighting axis Vₜ of the camera 18.

Thus, the “user experience” in the immersive piloting configuration is improved, a correlation between movement of the drone and sighting axis Vₜ of the camera being applied.

Optionally, it is possible for the user according to the invention to activate an additional option using a second command C₂ capable of reproducing the behavior of a fixed-wing drone, particularly of the “sailwing” type.

A fixed-wing drone, more particularly of the “sailwing” type, is capable of moving at high speeds, typically up to 80 km/h, which is, compared with a rotary wing drone, fairly difficult to pilot in light of its very high reactivity to piloting instructions sent from the remote control stick 16, and the need to maintain a minimum flight speed, greater than the takeoff speed.

The “sailwing” option described below aims to allow the user to a sailwing piloting experience with a rotary wing drone 14. In other words, it aims to allow the user to access the in-flight behavior of a sailwing while avoiding increased piloting difficulties generally associated with the sailwing.

Thus, according to a step 170, during the flight of the rotary wing drone 14, the electronic apparatus of FIG. 2 determines whether the user commands 124 comprise a second command C₂ for triggering the “sailwing” option within piloting mode 2 called “camera mode”.

In the absence N of this command C₂ within the user commands 124, no modification of the setpoint CN delivered by the previous step 166 occurs.

In the presence Y of this command C₂ within the user commands 124, a step 172 for controlling the speed of the drone 14 modified by the application A_Vmin of a predetermined minimum movement speed Vmin associated with each type of piloting instruction is carried out.

In other words, this aspect amounts to applying an offset of the minimum flight speed of the drone 14, such that the flight speed is, during the activation of this “sailwing” option, greater than the takeoff speed, specific to the behavior of a sailwing.

According to one specific aspect of this camera mode 1 with “sailwing” option, a step 174 is carried out to verify whether the piloting instruction I_{P} being carried out seeks to modify the roll angle φ of the rotary wing drone 14.

If no N, the navigation setpoint CN obtained after applying a predetermined minimum movement speed Vmin remains valid and is thus maintained.

In the affirmative Y, in other words in the presence both of the second command C₂, activating the sailwing option, and of a type of piloting instruction I_{P} capable of modifying the roll angle of the drone 14 according to a roll angle desired by the user, the type of associated navigation setpoint(s) CN remains independent of the sighting axis V of the camera 18, and the method then comprises a step 176 for determining C_V_{RH-C} a yaw angle ψ associated with the desired roll angle φ and a horizontal rotation speed setpoint of the camera 18.

The automatic application of a yaw angle ψ associated with the desired roll angle φ makes it possible in particular to reproduce the curve effect of the trajectory of a sailwing in the turning phase.

Furthermore, according to this specific aspect of the sailwing option of the camera mode, the horizontal rotation speed of the camera 18 is applied such that the piloting instruction I_{P} aiming to modify the roll angle of the drone 14 automatically induces, from the perspective of the image capture, a modification of the yaw angle.

A roll compensation of the camera stabilization 18 is thus obtained and allows the retrieval of an image captured by the camera 18 to have the tilted effect associated with the image capture that would be obtained onboard a sailwing.

In other words, this aspect aims to “imitate” the behavior of a sailwing, which, during a turn, becomes offset (i.e., the sighting axis of the camera “anticipates” the rotation of the drone 14 due to the turning and its inertia, so as to retrieve, for the user, the visual experience that he would perceive using a camera onboard a fixed-wing drone of the sailwing type during a turning phase).

Thus, when the sailwing option is selected by the user using the second command C₂, only the types of piloting instructions capable of modifying the pitch angle and/or the yaw angle and/or the movement speed of the drone 14 are associated with types of navigation setpoints obtained as a function of the sighting axis of the camera 18.

As an alternative, not shown, to the embodiment illustrated in FIG. 3, the sequence of steps previously described is modified. For example, after determination 152 by the electronic apparatus of FIG. 2 of the presence or absence of the first command C₁ for triggering piloting mode 1 in “camera mode”, the step 170 for determining the presence or absence of a second command C₂ for triggering the “sailwing” option is done. This step 170 is then followed by steps 172 for controlling the speed of the drone 14 modified by application A_Vmin of a predetermined minimum movement speed Vmin and 174 for verification of the type of piloting instruction I_{P} being executed seeks to modify, or not modify, the roll angle φ of the rotary wing drone 14.

If not N, the steps previously described 162 for determining the sighting axis V of the camera 18 to 166 for obtaining the navigation setpoints CNₜ based on the sighting axis are carried out.

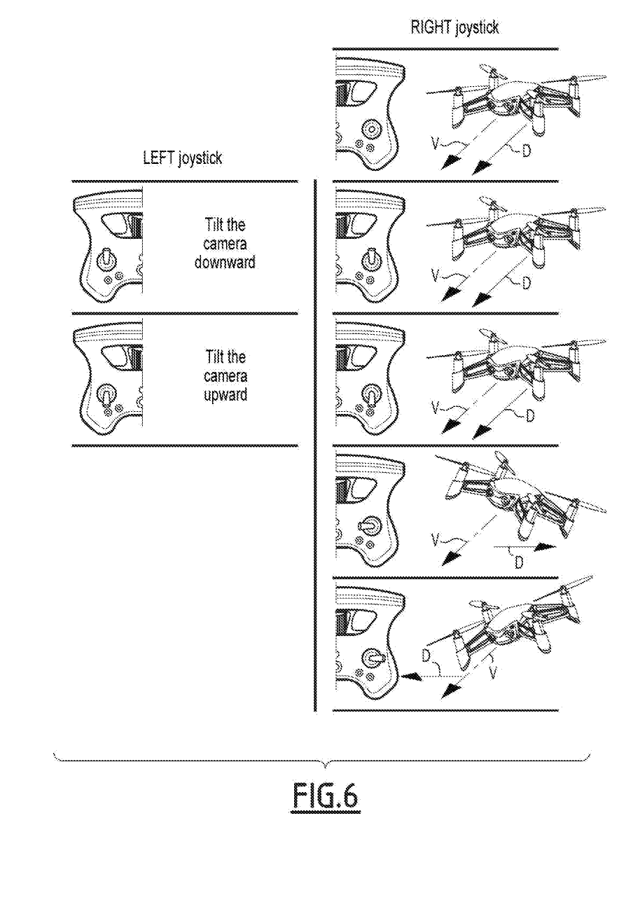

FIG. 5 illustrates an example of ergonomic distribution in camera mode 1 according to the invention of the commands available to the user on the remote control stick 16:
with the joystick located on the left (i.e., manipulated using the user's left hand), the user transmits, within user commands 124, incline or orientation instructions I_{C} of the camera 18 of the drone 14:
   with the stick actuated upward or downward, the user for example wishes to tilt the camera upward or downward, respectively, which corresponds, within the drone, to an angular speed control, i.e., in vertical rotation speed (tilt) of the camera 18 to obtain such a desired incline,
   with the stick actuated to the left or right, the user for example wishes to orient the camera to the left or right, respectively, which corresponds, within the drone, to an angular speed control, i.e., in horizontal rotation speed (yaw) of the camera 18 to obtain such a desired orientation,
with the joystick located on the right (i.e., manipulated using the user's right hand), the user transmits, within user commands 124, instructions I_{P} for piloting the drone 14:
   with the stick actuated upward or downward, the user respectively wishes for the movement D of the drone to involve coming closer to or further from, along the sighting axis V of the camera indicated by the left joystick, in other words, zooming in or out owing to the movement D alone of the drone, which corresponds within the drone to a vertical speed V_{Z} (throttle) and horizontal speed V_{H} (pitch angle) control with slaving on the sighting axis V (i.e., slaving to the orientation angles, which may or may not be virtual, of the capture area of the camera) as previously described,
   with the stick actuated to the left or right, the user wishes for a lateral movement D respectively on the left or the right of the drone, which corresponds to an attitude control of the drone according to the roll angle.

FIG. 6 illustrates another example of ergonomic distribution of the commands available to the user on the remote control stick 16 in camera mode 1 with sailwing option as previously described according to the invention:
with the joystick located on the left (i.e., manipulated using the user's left hand), the user transmits, by actuating it upward or downward, within user commands 124, instructions I_{C} for controlling the vertical position of the camera 18 of the drone 14 (i.e., when the user releases the joystick, the sighting axis V of the camera automatically returns to target the horizon, which automatically causes the return to a horizontal position of the drone 14). In other words, when the sailwing option is activated, unlike the camera mode without activation of this option as previously described in connection with FIG. 5, the control of the camera is different by acting here directly and precisely on its position and not on the control of its angular speed.
with the joystick located on the right (i.e., manipulated using the user's right hand), the user transmits, within user commands 124, instructions I_{P} for piloting the drone 14:
   with the stick in the center, the user wishes for the movement D of the drone to involve coming closer with a predetermined slow pace, for example 7 m/s, so as to generate a slower zoom, which corresponds within the drone to a vertical speed V_{Z} (throttle) and horizontal speed V_{H} (pitch angle) control with slaving on the sighting axis V (i.e., slaving to the orientation angles, which may or may not be virtual, of the capture area of the camera) as previously described,
   with the stick actuated upward or downward, the user respectively wishes for the movement D of the drone to involve coming closer with a predetermined fast pace, for example 12 m/s and greater than that associated with the stick in the center, or a slowdown, for example so as to reach a speed of 2 m/s during the ongoing approach along the sighting axis V, of the camera indicated by the left joystick, which corresponds within the drone to a vertical speed V_{Z} (throttle) and horizontal speed (pitch angle) control with slaving on the sighting axis as previously described,
   with the stick actuated to the left or right, the user wishes for a movement D respectively corresponding to an offset on the left or right of the drone 14, which corresponds to an attitude control of the drone according to the roll angle and a yaw angle automatically associated so as to imitate the curve effect of a sailwing in the turning phase, such a movement D of the drone being specifically associated, according to this sailwing mode, with a control of the horizontal rotation speed of the camera (i.e., the offset of the drone 14 to the left or right automatically induces, from the perspective of capturing an image, a change of the yaw angle).

In other words, with this sailwing option, the commands entered along the vertical axis by the user on the right joystick seek to manage the movement pace D of the drone 14, the minimum value Vmin of which is positive or zero, allowing a slowdown, or even stopping if the right joystick is actuated downward (i.e., toward the rear) maximally. In other words, relative to the commands entered along the vertical axis of the camera mode without sailwing option or the traditional piloting mode, scaling and a positive offset of the movement speed instructions are done.

Comparing FIGS. 5 and 6 shows that for a same user command entered on the control stick 16 by the user, a different movement D of the drone will be carried out based on the activated mode or piloting option.

Thus, the user with a same rotary wing drone 14 is able to access various piloting modes, for each of which he benefits from automatic piloting assistance owing to the electronic piloting apparatus illustrated in FIG. 2, namely:
a “traditional piloting mode”, where the movement of the rotary wing drone 14 is decorrelated from the image acquisition,
a “camera piloting mode”, where the movement of the rotary wing drone 14 is adjusted automatically so as to optimize the image acquisition, and
within this camera mode, a sailwing piloting option that seeks to optimize the movement of the rotary wing drone 14 to visually re-create the behavior of a sailwing.

Using a same rotary wing drone 14, the user experience is therefore enriched.

1. A method for piloting a rotary wing drone, the method being implemented by an electronic apparatus for piloting the drone, the drone being configured to have an onboard camera,
the method comprising calculating different types of navigation setpoint(s) of the drone, based on different types of piloting instructions for the movement of the drone, a type of piloting instruction being capable of modifying at least an attitude angle of the drone and/or the movement speed of the drone, each type of piloting instruction respectively being associated with a type of navigation setpoints,
the calculation comprising, for at least one type of piloting instructions:
determining the sighting axis of the camera,
obtaining at least one navigation setpoint associated with said at least one type of piloting instructions based on the sighting axis of the camera.

2. The piloting method according to claim 1, wherein the determination of the sighting axis of the camera comprises processing an orientation instruction of the camera, received by the electronic piloting apparatus of the drone, and/or previously stored in the memory of the electronic piloting apparatus of the drone.

3. The piloting method according to claim 1, wherein the obtainment of at least one navigation setpoint based on the sighting axis automatically implements, using the electronic piloting apparatus of the drone, a change of coordinate system,
the change of coordinate system being based on the obtainment of a current triaxial coordinate system for calculating navigation setpoint(s) by rotating a previous triaxial coordinate system for calculating a navigation setpoint around an invariant axis of said previous coordinate system, converting one of the other two axes of the previous coordinate system into the sighting axis of the camera.

4. The piloting method according to claim 1, wherein the method comprises detecting a change of sighting axis of the camera and reiterating the calculation of at least one navigation setpoint of the drone upon each detected change of sighting axis.

5. The piloting method according to claim 1, wherein the method can be activated by entering a first predetermined user command.

6. The piloting method according to claim 1, wherein the method comprises controlling the speed of the drone modified by the application of a predetermined minimum movement speed associated with each type of piloting instruction, said application being able to be activated by entering a second predetermined user command.

7. The piloting method according to claim 6, wherein, when said second predetermined user command is present and when the type of piloting instruction is capable of modifying the roll angle of the drone according to a desired roll angle, the type of associated navigation setpoint(s) remains independent of the sighting axis of the camera,
the method then comprising determining a yaw angle associated with the desired roll angle and a horizontal rotation speed setpoint of the camera.

8. A non-transitory computer-readable medium including a computer program comprising software instructions which, when executed by a computer, carry out a method according to claim 1.

9. An electronic apparatus for piloting a rotary wing drone, configured to have an onboard camera,
the electronic apparatus comprising a unit for calculating different types of navigation setpoint(s) of the drone, based on different types of piloting instructions for the movement of the drone, a type of piloting instruction being capable of modifying at least an attitude angle of the drone and/or the movement speed of the drone, each type of piloting instruction respectively being associated with a type of navigation setpoints,
the calculation unit comprising, for at least one type of piloting instructions:
a module for determining the sighting axis of the camera,
a module for obtaining at least one navigation setpoint associated with said at least one type of piloting instructions based on the sighting axis of the camera.

10. A rotary wing drone, configured to have an onboard camera, the drone comprising at least one electronic piloting apparatus according to claim 9.
